(19) United States
(12) Patent Application Publication
(10) Pub. No.: US 2006/0012090 A1
(43) Pub. Date: Jan. 19, 2006

(54) Multi-direction tuned mass damper with unique assembly

(75) Inventors: Joe Cerri, Norwalk, OH (US); Jeremy Weilnau, Huron, OH (US)

Correspondence Address: HARNESS, DICKEY & PIERCE, P.L.C., P.O. BOX 828, BLOOMFIELD HILLS, MI, 48303, US

(73) Assignee: The Pullman Company, Milan, OH (US)

(21) Appl. No.: 11/174,947

(22) Filed: Jul. 5, 2005

Related U.S. Application Data
(60) Provisional application No. 60/587,895, filed on Jul. 14, 2004.

(51) Int. Cl. F16F 5/00

(52) U.S. Cl. 267/140.11

(57) ABSTRACT

A link assembly includes one or more mass damper assemblies. Each mass damper assemblies include an annular mass disposed around the center rod of the link and an elastomeric bushing disposed between the center rod and the annular mass. This design for the mass damper assembly provides tuned damping in multiple directions while simplifying the assembly of the mass damper assembly to the center rod.

### FIELD OF THE INVENTION

The present invention relates to a mass damper for an automotive suspension. More particularly, the present invention relates to a multi-directional mass damper which is assembled to a component of an automotive suspension.

### BACKGROUND OF THE INVENTION

As a type of vibration damping device for reducing vibrations of a rod-shaped member, such as a shaft, a torque rod or a suspension link, used in various suspension components, there is known a mass damper having a single direction of tuned functionality. The single direction limitations of the prior art damping devices is due to their construction. Typically these prior art mass dampers consist of a rubber pad having a mass chemically bonded to one side of the rubber pad. A mounting bracket chemically bonded to the other side of the rubber pad is utilized to mount or attach the mass damper to the vibrating component. The design for the rubber pad and the mass are chosen to have a natural frequency that corresponds to the natural frequency that needs to be damped.

One problem with the prior art mass dampers is that they are limited to providing improved damping in only a single direction. When a specific application requires that vibration damping is required in multiple directions, the only option is to provide a separate single direction mass damper for each direction that requires damping.

### SUMMARY OF THE INVENTION

The present invention provides the art with a multi-directional damper which effectively dampens vibrations in multiple directions. The design for the multi-directional damper also provides for a unique and uncomplicated method for assembly, saving both time and money.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a link assembly incorporating a mass damper in accordance with the present invention;

FIG. 2 is a plan view of the link assembly illustrated in FIG. 1;

FIG. 3 is an end view of one of the mass dampers illustrated in FIGS. 1 and 2;

FIG. 4 is a side cross-sectional view of the mass damper illustrated in FIG. 3;

FIG. 5 is an end view similar to FIG. 3 but illustrating a mass damper in accordance with another embodiment of the invention;

FIG. 6 is an end view of the other mass damper illustrated in FIGS. 1 and 2; and

FIG. 7 is a side cross-sectional view of the mass damper illustrated in FIG. 5.

### DETAILED DESCRIPTION OF THE PREFERRED EMBODIMENTS

The following description of the preferred embodiment(s) is merely exemplary in nature and is in no way intended to limit the invention, its application, or uses.

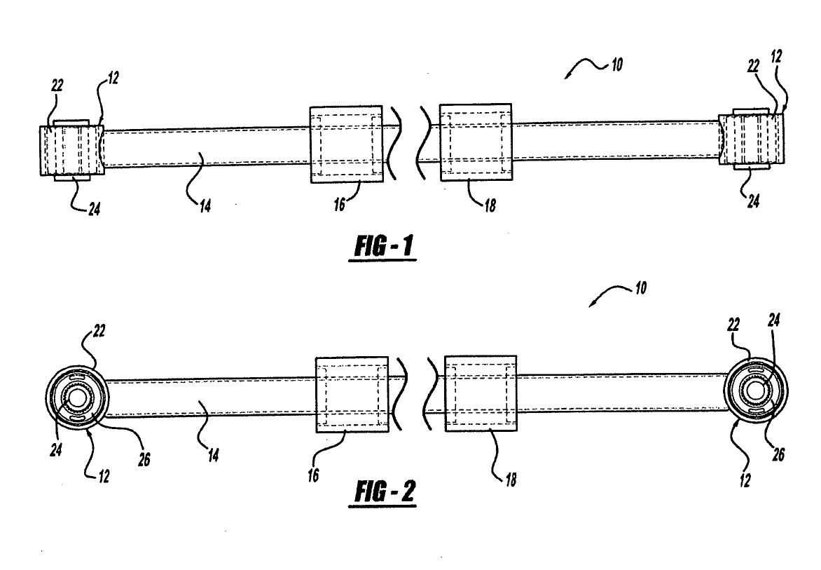

There is illustrated in FIGS. 1 and 2 a link assembly 10 which incorporates mass dampers in accordance with the present invention. Link assembly 10 comprises a pair of fittings in the form of elastomeric bushing assemblies 12, a solid or tubular center rod 14, a mass damper assembly 16 and a mass damper assembly 18.

Each elastomeric bushing assembly 12 comprises an eyelet 22, a center connection fitting 24 and an elastomeric bushing 26 disposed between eyelet 22 and center connection fitting 24. Each elastomeric bushing assembly 12 is attached to an end of center rod 14 by welding or by other means known in the art. Link assembly 10 is connected between two components of a suspension system utilizing the appropriate connectors and center connection fittings 24.

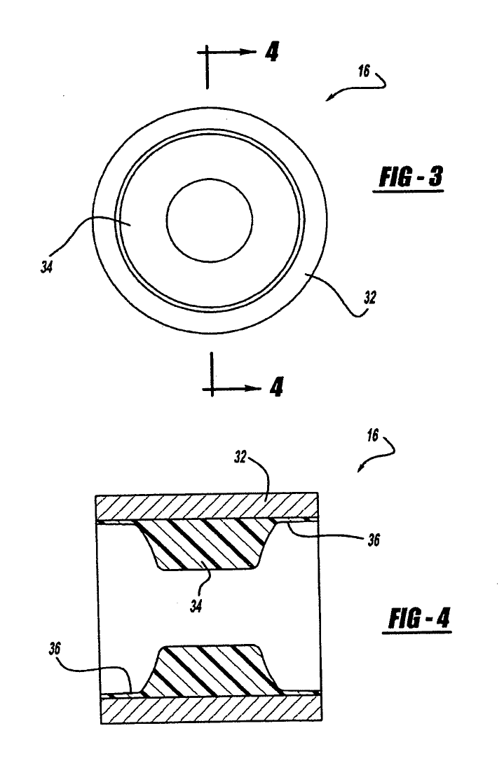

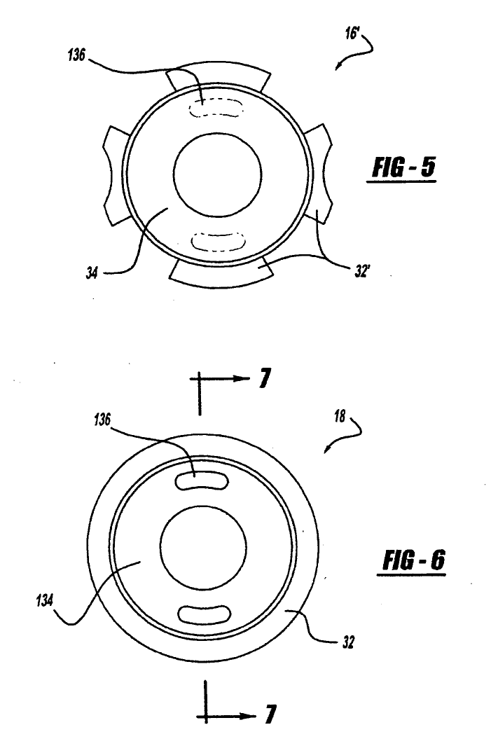

Referring now to FIGS. 3 and 4, mass damper assembly 16 is illustrated in greater detail. Mass damper assembly 16 comprises an outer annular mass 32 and an inner elastomeric bushing 34. The design for elastomeric bushing 34 is chosen to damp a single specific frequency and it may include one or more annular cut outs 36 to tune it to the correct frequency. Elastomeric bushing 34 is mechanically or chemically bonded to annular mass 32 and the size and design for mass 32 is also chosen based upon the natural frequency to be damped. While annular mass 32 is illustrated as having a constant wall thickness, it is within the scope of the present invention to vary the wall thickness of the annular mass to have different frequency responses in specific radial directions as illustrated in FIG. 5.

FIG. 5 illustrates a mass damper assembly 16′ which comprises outer mass 32′ and inner elastomeric bushing 34. Elastomeric bushing 34 is mechanically or chemically bonded to outer mass 32′ similar to that described above for mass damper assembly 16. Mass damper assembly 16′ is the same as mass damper assembly 16 described above except for the replacement of outer mass 32 with outer mass 32′. Outer mass 32′ is a multiple piece mass where the individual pieces are different sizes and thus different masses. Outer mass 32′ has a first natural frequency in one radial direction and a different second natural frequency in a second radial direction which will dampen different frequencies in the different radial directions due to the variable sized multi-piece construction of outer mass 32′. While outer mass 32′ is illustrated as a multiple piece mass, it is within the scope of the present invention to utilize a single piece mass 16′ which includes the different wall thickness or masses arranged circumferentially around elastomeric bushing 34.

The assembly of mass damper assembly 16 or 16′ is accomplished by stretching the inner diameter of elastomeric bushing 34 and sliding the pre-assembled mass damper assembly 16 or 16′ onto center rod 14 prior to the welding of one or both of eyelets 22 of elastomeric bushing assemblies 12. Once positioned at the proper axial and circumferential position on center rod 14, mass damper assembly 16 or 16′ is held in position by mechanically or chemically bonding elastomeric bushing 34 to center rod 14. The bonding of elastomeric bushing 34 to center rod 14 removes the need for fasteners and/or bolted joints to attach the mass damper to the suspension link. Once the mass dampers have been bonded to center rod 14, the assembly continues with the welding of the remaining eyelets 22 and the assembly of elastomeric bushing assemblies 12.

Mass damper assembly 16 or 16′ is capable of damping vibrations in multiple radial directions and thus eliminates the need for having a separate tuned damper for each direction that requires additional damping.

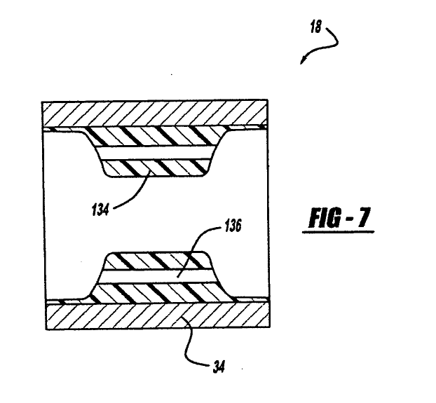

Referring now to FIGS. 6 and 7, mass damper assembly 18 is illustrated in greater detail. Mass damper assembly 18 comprises outer annular mass 32 and an inner elastomeric bushing 134. Elastomeric bushing 134 is the same as elastomeric bushing 34 except that elastomeric bushing 134 includes one or more voids 136 to provide different frequency responses in specific radial directions. The design for elastomeric bushing 134 is chosen to have a first natural frequency in a first radial direction and a different second natural frequency in a second radial direction to dampen a first specific frequency in the first specific radial direction due to the incorporation of voids 136 and a second specific frequency in the second radial direction due to the elimination of voids 136. Elastomeric bushing 134 is mechanically or chemically bonded to annular mass 32. While mass damper assembly 18 is illustrated incorporating annular mass 32, it is within the scope of the present invention to incorporate annular mass 32′ in place of annular mass 32. This design is illustrated in FIG. 5 where voids 136 have been shown in phantom.

The assembly of mass damper assembly 18 is the same as that described above for mass damper assembly 16 and once assembled, mass damper assembly 18 is held in position by mechanically or chemically bonding elastomeric bushing 134 to center rod 14.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A link assembly comprising:
a center rod;
a fitting disposed at each end of the center rod;
a mass damper assembly attached to said center rod, the mass damper assembly including an annular mass disposed around the center rod and an elastomeric bushing disposed between the center rod and the annular mass, the mass damper assembly defining a first natural frequency in a first radial direction and a second natural frequency in a second radial direction, the first natural frequency being different from the second natural frequency.

2. The link assembly according to claim 1, wherein the elastomeric bushing defines a first void between the center rod and the annular mass in the first radial direction.

3. The link assembly according to claim 2, wherein the elastomeric bushing defines a second void between the center rod and the annular mass.

4. The link assembly according to claim 3, wherein the second void is disposed opposite to the first void.

5. The link assembly according to claim 1, wherein the annular mass defines a variable wall thickness circumferentially around the annular mass.

6. The link assembly according to claim 5, wherein the elastomeric bushing defines a first void between the center rod and the annular mass in the first radial direction.

7. The link assembly according to claim 6, wherein the elastomeric bushing defines a second void between the center rod and the annular mass.

8. The link assembly according to claim 7, wherein the second void is disposed opposite to the first void.

9. The link assembly according to claim 1, wherein the annular mass defines a first wall thickness in the first radial direction and a second wall thickness in the second radial direction, the first wall thickness being different than the second wall thickness.

10. The link assembly according to claim 9, wherein the elastomeric bushing defines a first void between the center rod and the annular mass in the first radial direction.

11. The link assembly according to claim 10, wherein the elastomeric bushing defines a second void between the center rod and the annular mass.

12. The link assembly according to claim 11, wherein the second void is disposed opposite to the first void.

13. A mass damper assembly comprising:
an annular mass; and
an elastomeric bushing disposed within the annular mass, the elastomeric bushing defining an aperture, the mass damper assembly defining a first natural frequency in a first radial direction and a second natural frequency in a second radial direction, the first natural frequency being different than the second natural frequency.

14. The link assembly according to claim 13, wherein the elastomeric bushing defines a first void between the aperture and the annular mass in the first radial direction.

15. The link assembly according to claim 14, wherein the elastomeric bushing defines a second void between the aperture and the annular mass.

16. The link assembly according to claim 15, wherein the second void is disposed opposite to the first void.

17. The link assembly according to claim 16, wherein the annular mass defines a variable wall thickness circumferentially around the annular mass.

18. The link assembly according to claim 17, wherein the elastomeric bushing defines a first void between the center rod and the annular mass in the first radial direction.

19. The link assembly according to claim 18, wherein the elastomeric bushing defines a second void between the center rod and the annular mass.

20. The link assembly according to claim 19, wherein the second void is disposed opposite to the first void.

21. The link assembly according to claim 13, wherein the annular mass defines a first wall thickness in the first radial direction and a second wall thickness in the second radial direction, the first wall thickness being different than the second wall thickness.

22. The link assembly according to claim 21, wherein the elastomeric bushing defines a first void between the center rod and the annular mass in the first radial direction.

23. The link assembly according to claim 22, wherein the elastomeric bushing defines a second void between the center rod and the annular mass.

24. The link assembly according to claim 23, wherein the second void is disposed opposite to the first void.
